(19) United States
(12) Patent Application Publication
(10) Pub. No.: US 2003/0075228 A1
(43) Pub. Date: Apr. 24, 2003

(54) Flexible duct and its method of fabrication

(76) Inventor: Stephen W. Tippett, New Boston, NH (US)

Correspondence Address: Samuels, Gauthier & Stevens, LLP, 225 Franklin Street, Suite 3300, Boston, MA, 02110, US

(21) Appl. No.: 10/292,614

(22) Filed: Nov. 12, 2002

Related U.S. Application Data
(62) Division of application No. 09/599,694, filed on Jun. 22, 2000.

(51) Int. Cl. F16L 11/00; B31C 1/00

(52) U.S. Cl. 138/125; 156/144; 156/143

(57) ABSTRACT

A flexible duct comprises inner and outer perfluoroplastic tubes with a melt bondable adhesive interposed therebetween. A resilient helical coil is interposed between the adhesive and one of the tubes. The adhesive serves to thermally laminate the tubes together at wrinkled locations between the turns of the coil.

### RELATED APPLICATIONS

This application claims priority from Provisional patent application Serial No. 60/143,013 filed Jul. 9, 1999, and from Provisional patent application Serial No. 60/158,791 filed Oct. 12, 1999.

### BACKGROUND OF THE INVENTION

1. Field of the Invention

This invention relates generally to flexible ducts of the type employed to convey various fluids, including gases and/or liquids, which may or may not be corrosive, under varying pressure and temperature conditions.

2. Description of the Prior Art

For many years now, the fabric duct industry has been producing round flexible ducts reinforced with helical metal coils and incorporating a variety of fabrics, such as PVC, cotton, various rubber materials, urethanes, etc. The flexible ducts of this type are virtually everywhere. Because the ducts must be capable of handling both positive and negative pressure, the duct fabrics must be bonded, in some manner, to the helical metal coils.

Ducts of this type are typically manufactured by one of two methods. One existing commercial method involves literally clamping or crimping relatively narrow fabric strips in a helical pattern around a metallic reinforcement. Because this is strictly a mechanical joinder, only materials that can tolerate the stress of the mechanical clamping or crimping can be used in the process. Other drawbacks include leakage that inevitably occurs between the crimped fabric strips, and damage of the metallic reinforcement when the ducts are exposed to corrosive environments.

The other method involves encapsulating the metal coils between the duct fabric and an additional strip, often of the same fabric. The encapsulation is achieved via a chemical bonding or heat bonding of the two fabric materials, for example a PVC coated polyester fabric with a PVC film.

The manufacturers of flexible ducting select easily bondable and/or heat sealable materials for the encapsulation method. Although many polymers qualify, a few highly desired polymers with exceptional traits cannot be easily bonded or heat sealed. Silicone is one such polymer. Others include materials within the family of perfluoroplastics. The perfluoroplastics are particularly preferred materials because of their chemical, thermal, and nonflammable traits. Also, in some forms, particularly laminates of polytetrafluoroethylene (“PTFE”), exceptional mechanical traits can be achieved. Prior to the present invention, for these polymers which cannot be easily bonded or heat sealed, the crimping process with all of its attendant drawbacks, provided the only viable avenue for duct manufacturers.

### SUMMARY OF THE INVENTION

An objective of the present invention is the provision of an improved flexible duct fabricated from the preferred but difficult to heat seal or bond perfluoroplastics, by a novel thermal bonding method which avoids all of the drawbacks of conventional crimping methods.

In accordance with the present invention, a resilient helical coil is captured between inner and outer tubes formed of a perfluoroplastic material. The tubes are thermally laminated or heat sealed together at locations other than those occupied by the helical coil by means of a melt bondable adhesive interposed between the helical coil and one of the tubes.

The resultant duct is both flexible and nonporous. The resilient helical coil is completely encapsulated between the inner and outer tubes. The inner tube is securely bonded to the outer tube, thus enabling the duct to operate reliably under negative as well as positive pressure conditions, and at elevated temperatures. The duct is corrosion resistant and nonflammable. By selecting a dielectric perfluoroplastic material for the helical coil, the entire duct becomes electrically non conductive.

These and other features, objectives and advantages of the present invention will now be described in greater detail with reference to the accompanying drawings, wherein:

### BRIEF DESCRIPTION OF THE DRAWINGS

FIG. 1 is a perspective view of a flexible duct in accordance with the present invention;

FIG. 2 is an exploded perspective view of some of the major components of the flexible duct;

FIG. 3 is an enlarged partial sectional view taken along line 3-3 of FIG. 1;

FIGS. 4A-4E are diagrammatic depictions of various stages during the fabrication of the flexible duct;

FIGS. 5A and 5B diagrammatically depict stages in the formation of the tube components; and

FIGS. 6A-6C depict various cross sections for extruded PTFE rods useful in forming helical coils.

### DETAILED DESCRIPTION OF PREFERRED EMBODIMENTS

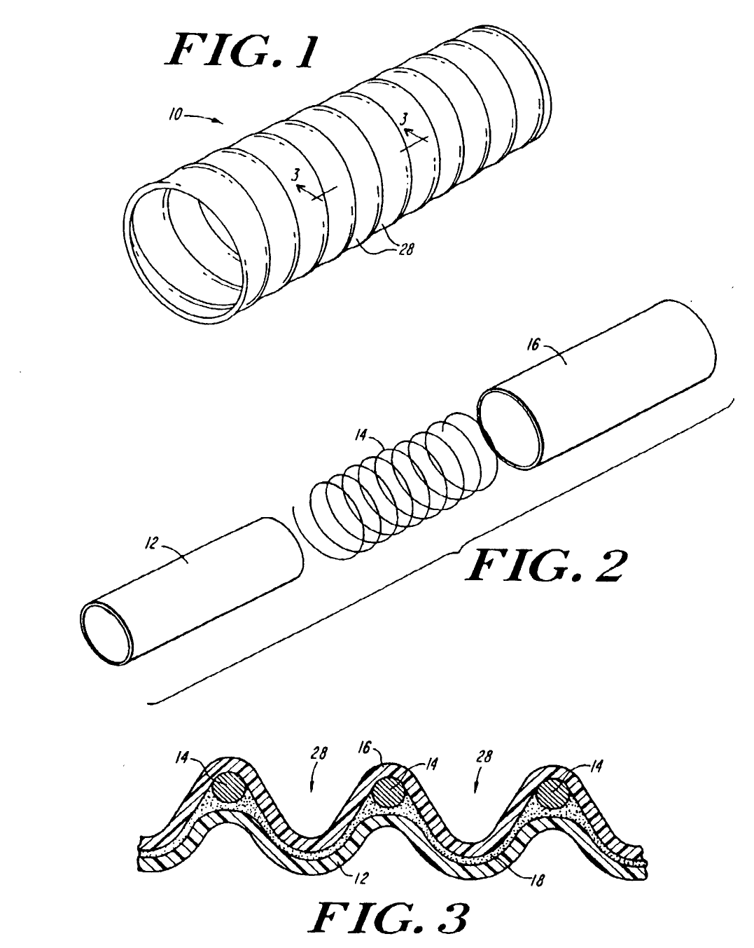

Referring initially to FIG. 1, a flexible duct in accordance with the present invention is generally depicted at 10. As can best be seen by additional reference to FIGS. 2 and 3, the duct 10 includes as basic components a corrosion barrier inner tube 12, a flexible and resilient helical coil 14, an outer tube 16, and a melt bondable adhesive 18 (shown only in FIG. 3) interposed between the tubes 12, 16 and, where the coil is present, between the coil and one of the tubes, for example and as illustrated, between the coil and the inner tube.

The inner and outer tubes 12, 16 are formed from perfluoroplastic materials which may comprise:

a) films of PTFE in skived, cast or extruded and oriented form; blends of PTFE and fluoroelastomers; blends of polyimide and PTFE; TFM, a modified form of PTFE supplied by Dyncon, LLC of Aston, Pa.;

b) Laminates of PTFE films, preferably extruded and oriented, in expanded or unexpanded form, including LFP;

c) Composites, e.g., woven fabrics or textiles coated or surface laminated with FEP, PFA, PTFE; blends of perfluoroplastics and fluoroelastomers; and blends of polyimide and PTFE. The woven fabrics or textiles may consist of fiberglass, amorphous silica, graphite, polyaramides, polybenzimadazole, ceramics, metal wires and combinations thereof.

Materials may be in either the sintered or unsintered form. Unsintered materials will become sintered during the fabrication process.

Of the above materials, LFP is preferred.

The helical coil 14 may be fabricated from spring tempered carbon steel, stainless steel or other steel alloys. Alternatively, the coil may be formed from a nonmetallic dielectric material, preferably sintered PTFE or LFP. When employing a coil formed from an extruded PTFE rod, it may be advantageous to provide a cross section with one or more flat surfaces. For example, the rod may be extruded with a rectangular cross section (FIG. 6A), a square cross section (FIG. 6B), or with only two opposed flat surfaces (FIG. 6C).

The melt bondable adhesive 18 may comprise PFA, FEP or unsintered PTFE.

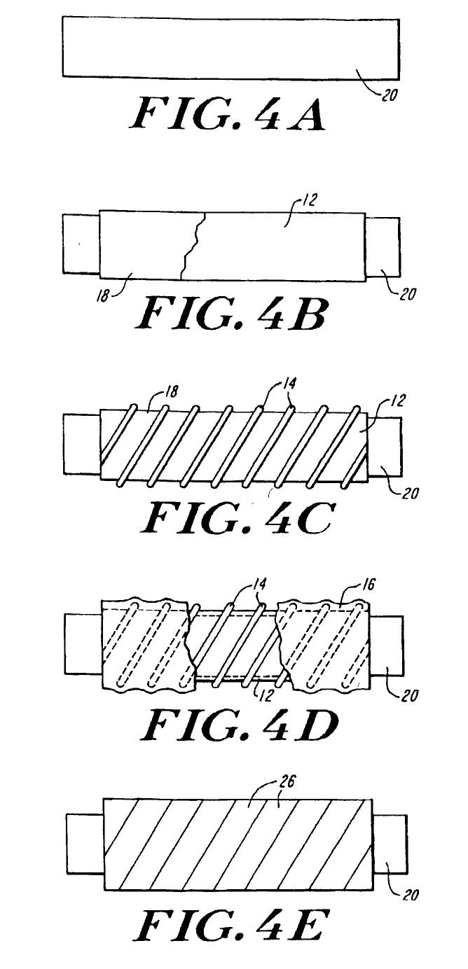

The method of producing a length of flexible duct in accordance with the present invention will now be described with reference to FIGS. 4A-4E.

As shown in FIG. 4A, a pressure core 20 is provided. The pressure core will typically consist of a round lightweight metal duct wrapped with high temperature insulation fabrics. Alternatively, the pressure core can consist of rolled pieces of insulation materials or fabrics. The insulation fabrics can consist of woven and nonwoven materials, including fiberglass, amorphous silica, graphite, polyaramides, polybenzimadazole, ceramics and combinations thereof. In a preferred assembly, the interior metal duct of the pressure core collapses to ease its removal from the completed flexible duct. The pressure core may also comprise a pneumatic assembly, or other mechanical systems designed to provide a radially adjustable internal member.

As shown in FIG. 4B, the pressure core 20 is initially surrounded by the corrosion barrier inner tube 12. The tube 12 can either be preformed before being axially inserted over the pressure core, or it can be formed in situ on the pressure core. As herein employed, the term “in situ” is intended to described formation of a duct component during rather than separately from formation of the entire duct assembly.

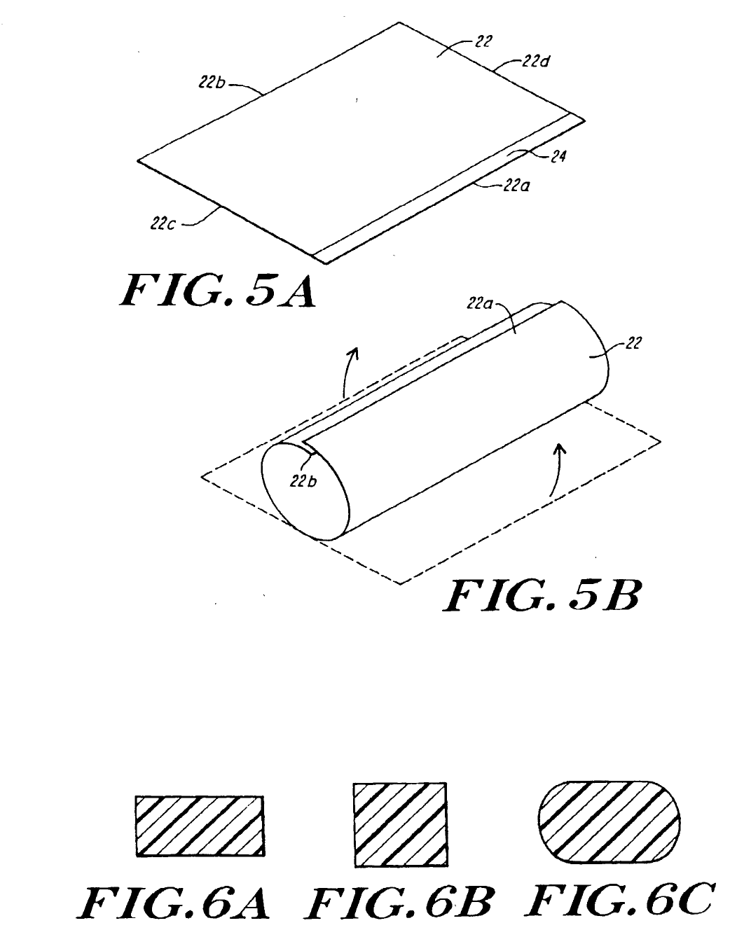

In either case, as shown in FIGS. 5A and 5B, the tube 12 is formed from a rectangular sheet 22 of perfluoroplastic material having side edges 22a, 22b and end edges 22c, 22d. A strip 24 of a melt bondable adhesive material, e.g., PFA, is applied along edge 22a, and the sheet is then formed into a cylinder, with edge 22a overlapping edge 22b, and with the PFA strip 24 located between the overlapped edges. Heat is then applied to heat seal the overlapped edges to produce a seam. When the tube is preformed before being mounted on the mandrel, the seam can be produced by applying a heated sealing iron to the overlapping edges. However, when the tube is formed in situ, heat sealing can take place when the entire tube assembly is heated, as will be explained more fully hereinafter.

The inner tube 12 may be covered with the melt bondable adhesive 18, either by a coating process applied to the sheet material 22 prior to formation of the tube, or by wrapping a thin film of melt bondable material around the tube 12 after it has been positioned on the pressure core.

With reference to FIG. 4C, the helical coil 14 is then mounted on the pressure core 20 over the adhesive covering on the corrosion barrier inner tube 12. The coil can be preformed and axially inserted in place, or it can be formed by helically wrapping a wire or the like around the inner tube 12.

As shown in FIG. 4D, the coil 14 is surrounded by the outer tube 16, which also can either be preformed, or formed in situ, in the same manner as described previously in connection with the formation and application of the inner tube 12.

As an alternative to applying the adhesive covering 18 to the outer surface of the inner tube 12, the same covering can be applied to the interior surface of the outer tube 16. In any case, however, the adhesive is ultimately positioned between the inner and outer tubes in all locations except those occupied by the coil. Where the coil is present, the adhesive is located between one of the tubes and the coil.

After the duct components comprising the inner and outer tubes 12, 16 the coil 14 and the melt bondable adhesive 18 have been assembled on the pressure core 20, and as shown in FIG. 4E, a high temperature ribbon 26 is then helically wrapped around the assembly to cover the areas between the mutually spaced turns of the coil 14. The tubes 12, 16 are compressed between the wound ribbon 26 and the pressure core 20 into intimate contact with the melt bondable adhesive 18 interposed therebetween. The tightly wound ribbon also assists in maintaining the spacing between the turns of the coil. The ribbon may comprise any suitable high temperature material, including for example fiberglass lightly coated with PTFE.

With the ribbon 26 firmly in place, the entire package is then placed in a high temperature environment for a period of time necessary to melt the melt bondable adhesive 18. Typically, the package will be held in an oven heated to about 700° F. for a residence time of about fifteen minutes.

The package is then allowed to cool while the components of the duct assembly remain in a radially compressed state, i.e., with both the pressure core 20 and outer helically wound tape 26 in place. By cooling the assembly in this radially compressed state, an excellent bond is achieved between the inner and outer tubes in all areas other than those occupied by the helical coil interposed therebetween.

After cooling has taken place, the outer helically wound tape 26 is unwound and removed from the outer tube, and the mandrel is extracted axially from the inner tube. The resilient duct is then compressed axially to induce wrinkling as at 28 (see FIGS. 1 and 3) between the turns of the coil 14. This reduces the overall length of the duct while imparting flexibility to the finished product.

### EXAMPLES

### Example #1

A 3″ ID flexible duct, 10″ long, was manufactured with both a corrosion barrier inner tube and an outer tube manufactured from LFP 2109. A helical wire coil having a 3″ ID, a length of 12″, and a 0.5″ spacing between coil turns was manufactured using #14 tempered spring steel (0.063″).

The corrosion barrier inner tube was produced using a ½″ overlap heat sealed splice with a 0.005″ PFA film (500LP; E. I. Dupont, Wilmington, Del.) serving as the melt bondable adhesive. The inner tube was formed with a 3″ ID and a 12″ length. A one mil (0.001″) PFA film was thermally tacked to the exterior surface of the corrosion barrier inner tube.

The outer tube was also produced using a ½″ overlap heat sealed splice with 0.005″ PFA film as the melt adhesive. The tube was formed with a 3¼″ ID and a 12″ length.

The internal pressure core was manufactured using ½″ needled fiberglass insulation mat (9 lb/cu ft density, BGF Industries, Inc., Greensboro, N.C.). The mat was rolled into a log with a 3″ ID and a 12″ length.

To produce the flexible duct, the corrosion barrier inner tube was slipped over the internal pressure core. The wire coil was then slipped over the corrosion barrier inner tube. Next, the outer cover tube was pulled over the entire assembly. Finally, the assembly was wrapped tightly with a lightly coated PTFE fiberglass fabric (Style 7544 fabric, 18 oz/sq yd, BGF Industries, Inc., Greensboro, N.C.). The coating weight of PTFE on the fabric was 2-3 oz/sq yd (ALGOFLON D60G PTFE dispersion, Ausimont USA, Thorofare, N.J.). The fabric wrap was held in place by strips of lightweight fiberglass fabric that were tied around the fabric wrap. The entire package was placed in a 700° F. convection hot air oven for 15 minutes. The package was suspended by metal rods at each end to ensure uniform heating throughout the package.

At the conclusion of the heating step, the package was removed from the oven and allowed to cool to room temperature. Thereafter, the fabric wrap and internal pressure core were removed. The flexible duct was then compressed axially to form wrinkles between the coil turns. When the wrinkles were formed, the length of the duct reduced from 12″ to approximately 10″ in length.

An inspection of the flexible duct revealed that adhesion had developed in random areas between the outer tube and the inner tube in the areas between the coil turns. However, it was very noticeable that the two tubes were not tightly bonded around the wire coil. A visual examination showed that approximately 60% of the area residing between the coil turns contained heat sealed bonds between the two tubes. The ½″ distance between the coils reduced to ⅜″. Finally, wrinkles could be observed in the outer cover that extended for the entire length of the duct. The wrinkles were the result of the tight wrap of the fiberglass fabric on the assembly.

The flexible duct possessed some stiffness but could be readily flexed without much effort.

### Example #2

A 3″ ID flexible duct, 10″ long, was manufactured with both the corrosion barrier inner tube and the outer tube manufactured from LFP 2109. The wire coil was manufactured using #14 tempered spring steel (0.063″), with a 3″ ID, a ¾″ distance between turns, and a length of 12″.

The corrosion barrier inner tube was produced using a ½″ overlap heat sealed splice and 0.005″ PFA film (500LP; E. I. Dupont, Wilmington, Del.) as the melt bondable adhesive. The tube was formed with a 3″ ID and a 12″ length. A light MFA coating was applied to the exterior surface of the corrosion barrier inner tube (Hyflon MFA; Ausimont USA; Thorofare, N.J.).

The outer tube was also produced using a ½″ overlap heat sealed splice with 0.005″ PFA film as the melt adhesive. The outer tube was formed with a 3¼″ ID and a 12″ length.

The internal pressure core was manufactured using a combination of ½″ needled fiberglass insulation mat and woven fiberglass fabric (Zetex 2200, 60 oz/sq yd, Newtex Industries, Victor, N.Y.). The mat was rolled into a log with a 2¾″ ID. The fiberglass fabric was wrapped around the insulation mat log, bringing the diameter of the internal pressure core to 3″.

To produce the flexible duct, the corrosion barrier inner tube was slipped over the internal pressure core. The wire coil was then slipped over the corrosion barrier tube. Next, the outer cover tube was pulled over the entire assembly. Finally, the assembly was wrapped tightly in lightly coated PTFE fiberglass fabric strips that were ½″ wide (Style 7544 fabric, 18 oz/sq yd, BGF Industries, Inc., Greensboro, N.C.). The coating weight of PTFE on the fabric strips was 2-3 oz/sq yd (ALGOFLON D60G PTFE dispersion, Ausimont USA, Thorofare, N.J.). The fabric strips were wrapped between the coil turns, providing maximum lamination pressure for bonding the two tubes together. The fabric strips also assisted in maintaining uniform spacing for the coil turns. The entire package was placed in a 700° F. convection hot air oven for 15 minutes. The package was suspended by metal rods on each end to ensure uniform heating throughout the package.

At the conclusion of the heating step, the package was removed from the oven and allowed to cool to room temperature, after which the fabric wrap and internal pressure core were removed. The flexible duct was compressed axially to form wrinkles between the coil turns. When the wrinkles were formed, the length of the duct reduced from 12″ to approximately 11″ in length.

An inspection of the flexible duct revealed that adhesion had developed uniformly in the areas between the inner and outer tubes. The two tubes were bonded more snuggly around the coil. The ¾″ distance between the coils reduced to roughly a ⅝″. Finally, wrinkles could be observed in the outer cover.

The duct was more flexible than the duct of Example #1.

### Example #3

A 4¼″ ID flexible duct, 20″ long, was manufactured with both the inner corrosion barrier tube and the outer tube manufactured from LFP 2109. The inner tube color was black. The outer tube color was blue. The wire coil was manufactured using #14 tempered spring steel (0.063″), with a 4¼″ ID, with a 1¼″ distance between coil turns, and a length of 22″.

The interior corrosion barrier tube was produced using a ½″ overlap heat sealed splice and 0.005″ PFA film as the melt bondable adhesive. The tube was manufactured with a 4¼″ ID and a 22″ length. One-half mil (0.0005″) PFA film was thermally tacked to the exterior surface of the corrosion barrier tube.

The outer tube was not preformed. Instead, it consisted of an LFP 2109 sheet, 22″×14.85″. Five mil (0.005″) PFA film was thermally tacked along one of the 22″long edges.

The internal pressure core was manufactured using a 3″ ID metal sleeve and woven fiberglass fabric (Zetex 2200, 60 oz/sq yd, Newtex Industries, Victor, N.Y.). The fiberglass fabric was wrapped around the metal sleeve, bringing the diameter of the internal pressure core to 4¼″.

To produce the flexible duct, the corrosion barrier inner tube was slipped over the internal pressure core. The coil was then slipped over the corrosion barrier tube. Next, the outer cover sheet was wrapped around the entire assembly so that the PFA tacked along the edge overlapped and faced inwardly to cover the opposite edge of the outer cover sheet. In this manner, the outer tube is formed in situ during the subsequent heating. Finally, the assembly was wrapped tightly in ¾″ wide lightly coated PTFE fiberglass fabric strips. The coating weight of PTFE on the fabric strips was 2-3 oz/sq yd. The fabric strips were wrapped between the coil turns, providing maximum lamination pressure for bonding the two tubes together. The entire package was placed in a 700° F. convection hot air oven for 15 minutes. The package was suspended by metal rods on each end to ensure uniform heating throughout the package.

At the conclusion of the heating step, the package was removed from the oven and allowed to cool to room temperature, after which the fabric wrap and internal pressure core were removed. The flexible duct was compressed axially to form wrinkles between the coil turns. When the wrinkles were formed, the length of the duct reduced from 22″ to approximately 20″ in length.

An inspection of the flexible duct revealed that adhesion had developed very uniformly between the inner and outer tubes at locations other than those occupied by the helical coil. The two tubes were bonded well in the vicinity around the coil. The 1¼″ distance between the coils reduced slightly. Finally, because the outer cover was produced in situ, far fewer wrinkles were observed in the exterior cover. The duct showed very good flexibility.

### Example #4

A 6″ ID flexible duct, 12″ long, was manufactured with both the interior corrosion barrier tube and the outer tube manufactured from LFP 2109. The inner tube color was black. The outer tube color was blue. The wire coil was manufactured using #14 tempered spring steel (0.063″), with a 6″ ID coil, a 1½″ distance between coil turns, and a coil length of 13″.

The corrosion barrier inner tube was produced using a ½″ overlap heat sealed splice and 0.005″ PFA film as the melt bondable adhesive. The tube was manufactured with a 6″ ID and a 13″ length. One-half mil (0.0005″) PFA film was thermally tacked to the exterior surface of the corrosion barrier tube.

The outer tube was formed in situ from an LFP 2109 sheet, 13″×20″. Five mil (0.005″) PFA film was thermally tacked along one of the 13″ long edges.

The internal pressure core was manufactured using a 5″ ID metal sleeve and woven fiberglass fabric (Zetex 2200, 60 oz/sq yd, Newtex Industries, Victor, N.Y.). The fiberglass fabric was wrapped around the metal sleeve, bringing the diameter of the internal pressure core to 6″.

To produce the flexible duct, the corrosion barrier inner tube was slipped over the internal pressure core. The wire coil was then slipped over the corrosion barrier tube. Next, the exterior outer cover LFP 2109 sheet was wrapped around the entire assembly so that the PFA tacked along the edge overlapped and faced against the opposite edge region of the sheet.

Next, a spiral wrap was applied to the assembly specifically over the coils. The wrap material consisted of LFP 2109 and 0.005″ PFA film. The LFP material was slit into a ½″ strip. PFA of the same width was then thermally tacked to one side of the LFP product. The ½″ wide strip was wrapped over the coil for the length of the duct, forming a thicker build of product on the coil for wear or abrasion protection.

Finally, the assembly was wrapped tightly in lightly coated PTFE fiberglass fabric strips that were 1¼″″ wide. The coating weight of PTFE on the fabric strips was 2-3 oz/sq yd. The fabric strips were wrapped in between the coil turns, providing maximum lamination pressure for bonding the two tubes together. The entire package was placed in a 700° F. convection hot air oven for 15 minutes. The package is suspended by metal rods at each end to ensure uniform heating throughout the package.

At the conclusion of the heating step, the package was removed from the oven and allowed to cool to room temperature, after which the fabric wrap and internal pressure core were removed. The flexible duct was compressed axially to form wrinkles between the coil turns. When the wrinkles were formed, the length of the duct reduced only slightly.

An inspection of the flexible duct revealed that adhesion had developed very uniformly between the inner and outer tubes in the areas between the coil turns. The ½″ LFP 2109 wear strip adhered well on the coil areas. Also, the two tubes were bonded well in the vicinity around the coil. The 2″ distance between the coils reduced very little. Finally, because the outer cover was produced in situ, far fewer wrinkles were observed in the exterior cover.

### Example #5

A 6″ ID flexible duct, 12″ long, was manufactured with both the corrosion barrier inner tube and the outer cover tube manufactured from EJ 1650 Insulation Jacketing Product, a PTFE coated fiberglass fabric (Style 332 fiberglass fabric, JPS Industries, Slater, S.C.; ALGOFLON D60G PTFE dispersion, Ausimont USA, Thorofare, N.J.). The PTFE resin content of the coated product was 25%, with 70% of the coating being applied to one side in a gray color. The color of the PTFE coating on the other side was black. The color of the interior surface of the corrosion barrier tube was gray. The color of the exterior surface of the outer tube also was gray. The wire coil was manufactured using #14 tempered spring steel (0.006″), with a 6″ ID coil, a 1½″ distance between coil turns, and a coil length of 13″.

The interior corrosion barrier tube was produced using a ½″ overlap heat sealed splice and 0.005″ PFA film as the melt bondable adhesive. The tube was manufactured with a 6″ ID and a 13″ length. One-half mil (0.0005″ ) PFA film was thermally tacked to the black exterior surface of the corrosion barrier tube.

The outer cover was formed in situ from an EJ 1650 sheet, 13″×20″. Five mil (0.005″) PFA film was thermally tacked along one of the black 13″ long edges.

The internal pressure core was manufactured using a 5″ ID metal duct and woven fiberglass fabric (Zetex 2200, 60 oz/sq yd, Newtex Industries, Victor, N.Y.). The fiberglass fabric was wrapped around the metal duct, bringing the diameter of the internal pressure core to 6″.

To produce the flexible duct, the corrosion barrier tube was slipped over the internal pressure core. The coil was then slipped over the corrosion barrier tube. Next, the exterior outer cover EJ 1650 sheet was wrapped around the entire assembly so that the PFA tacked along the edge overlapped and faced against the outer cover sheet.

Finally, the assembly was wrapped tightly in lightly coated PTFE fiberglass fabric strips that were 1¼″″ wide. The coating weight of PTFE on the fabric strips was 2-3 oz/sq yd. The fabric strips were wrapped in between the coil turns, providing maximum lamination pressure for bonding the two tubes together. The entire package was placed in a 700° F. convection hot air oven for 15 minutes. The package was suspended by metal rods at each end to ensure uniform heating throughout the package.

At the conclusion of the heating step, the assembly was removed from the oven and allowed to cool to room temperature, after which, the fabric wrap and internal pressure core were removed. The flexible duct was compressed axially to form wrinkles between the coil turns. When the wrinkles were formed, the length of the duct reduced only slightly.

An inspection of the flexible duct revealed that adhesion had developed between the inner and outer tubes in the areas between the coil turns. The two tubes appeared bonded well in the vicinity around the coil. The 2″ distance between the coils reduced very little. Few wrinkles were observed in the exterior cover. It is assumed that the few wrinkles were the result of the outer cover being laminated in situ.

### Example #6

The duct of Example #7 was mounted on a machine designed to effect repeated axial compression at the rate of 69 cycles per minute. One cycle consisted of compressing the duct by 6″ and then returning to its original 12″ length.

The duct was allowed to remain on the machine for 109 minutes of cycle flexing (7550 cycles), at which time a hole developed through both the inner and outer tubes, and the test was discontinued.

### Example #7

The duct of Example #6 was mounted on the machine described in Example #8.

The duct was allowed to remain on the machine for ten hours of cycle flexing (41,400 cycles), at which time a hole developed in both the inner and outer tubes, and the test was discontinued.

### Example #8

A 5″ ID flexible duct, 24″ long, was manufactured with both the interior corrosion barrier tube and the outer tube manufactured from LFP 2109. The inner tube color was black. The outer tube color was blue. The coil was manufactured using an extruded PTFE rod that was ⅜″ wide×3/16″ thick. A 5″ ID helical coil was produced with a 2″ distance between coil turns. The original coil length was 29″.

Both the interior corrosion barrier tube and outer tube were produced in situ from LFP sheets measuring 17″×29″. A five mil (0.005″) PFA film strip was thermally tacked along one of the 29″ long edges on both sheets. A one mil (0.001″) PFA film was tacked to one side of the exterior tube sheet to serve as the melt bonding adhesive.

The internal pressure core was manufactured using a 4¾″ ID metal duct and woven fiberglass fabric (Zetex 2200, 60 oz/sq yd, Newtex Industries, Victor, N.Y.). The fiberglass fabric was wrapped around the metal duct, bringing the diameter of the internal pressure core to 5″.

To produce the flexible duct, the interior tube sheet was wrapped around the pressure core so that the tacked PFA strip overlapped the opposite edge of the sheet. The PTFE rod was then helically wrapped around the interior sheet. Next, the exterior tube sheet was wrapped around the entire assembly so that the tacked PFA strip along its 29″ edge overlapped the opposite edge. Also, the exterior sheet was installed so that the tacked 1 mil PFA film faced inwardly.

Finally, the assembly was wrapped tightly in lightly coated ¾″ wide PTFE fiberglass fabric strips. The coating weight of PTFE on the fabric strips was 2-3 oz/sq yd. Care was taken to make certain the fabric strips were wrapped in between and over the coil turns, providing maximum lamination pressure. The entire package was placed in a 700° F. convection hot air oven for 30 minutes. The package was suspended by metal rods on each end to ensure uniform heating throughout the package.

When the 30 minutes had elapsed, the package was removed from the oven and allowed to cool to room temperature, after which the fabric wrap and internal pressure core were removed. The flexible duct was compressed by hand to form wrinkles between the coil turns. When the wrinkles were formed, the length of the duct reduced by 10-20%.

An inspection and analysis of the flexible duct revealed many details. First, the overlap splices for both the interior and exterior tube sheets bonded well in the in situ process, producing well sealed seams and well formed completely impervious inner and outer tubes. Also, the bond between the two tubes in areas between the coil turns was extremely uniform.

The outer tube sheet was laminated very tightly to three sides of the PTFE coil, readily displaying its rectangular profile and resulting in a strong bond. Additionally, a section of the flexible duct was removed and dissected to further examine lamination bonds. The outer tube sheet readily tore in every attempt to separate it from the PTFE coil.

Also, the pitch of the coil turns was remarkably uniform, indicating that the flat surfaces of the rectangular coil cross section assist in maintaining structural uniformity in the product during the heating process.

The completed duct was very flexible. Also, the PTFE coil displayed excellent durability, with an ability to “bounce back” to its original shape when heavily stressed.

I claim:

1. A flexible duct comprising:
an inner tube formed of a perfluoroplastic material;
an outer tube formed of a perfluoroplastic material, said outer tube surrounding said inner tube;
a melt bondable adhesive interposed between said inner and outer tubes; and
a resilient helical coil interposed between one of said tubes and said melt bondable adhesive, said adhesive serving to thermally laminate said inner and outer tubes together at locations other than those occupied by said coil.

2. The flexible duct of claim 1 wherein said perfluoroplastic material is PTFE.

3. The flexible duct of claim 1 wherein said perfluoroplastic material is LFP.

4. The flexible duct of claim 1 wherein said melt bondable adhesive has a melt temperature lower than that of said perfluoroplastic material.

5. The flexible duct of claim 1 wherein said helical coil is formed from a metal.

6. The flexible duct of claim 1 wherein said helical coil is formed from a perfluoroplastic material.

7. The flexible duct of claim 6 wherein said perfluoroplastic material is PTFE.

8. The flexible duct of claim 6 wherein said melt bondable adhesive serves to adhere said coil to one of said tubes.

9. The flexible duct of claim 6 wherein said melt bondable adhesive serves to adhere said coil to said outer tube.

10. A method of producing a flexible duct comprising the steps of:
a) providing a support mandrel;
b) surrounding said support mandrel with a tubular assembly including as components;
(i) an inner tube;
(ii) an outer tube;
(iii) a melt bondable adhesive interposed between said inner and outer tubes; and
(iv) a resilient helical coil interposed between one of said tubes and said melt bondable adhesive;
c) applying an outer wrapping to said outer tube to radially compress said components between said outer wrapping and said support mandrel;
d) heating the thus compressed components to an elevated temperature and for a period of time sufficient to integrally join said components by melting said adhesive and laminating said inner and outer tubes together at locations other than those occupied by said coil;
e) cooling the thus compressed and integrally joined components;
f) removing said outer wrapping from said outer tube and extracting said mandrel from said inner tube.

11. The method of claim 10 wherein said inner tube is formed in situ on said support mandrel.

12. The method of claim 10 wherein said helical coil is formed in situ on said inner tube.

13. The method as claimed in claim 10 wherein said outer tube is formed in situ on said coil.

14. The method as claimed in claim 10 wherein said inner tube is formed in situ on said mandrel, said helical coil is formed in situ on said inner tube, and said outer tube is formed in situ on said helical coil.

15. The method as claimed in claim 10 wherein the material from which said inner and outer tubes are formed comprises a perfluoroplastic.

16. The method as claimed in claim 15 wherein said perfluoroplastic is PTFE.

17. The method as claimed in claim 15 wherein the material from which said inner and outer tubes is formed comprises LFP.

18. The method as claimed in claim 15 wherein said melt bondable adhesive comprises a second perfluoroplastic having a melt temperature lower than that of said first mentioned perfluoroplastic.

19. The method as claimed in claim 18 wherein said first mentioned perfluoroplastic is PTFE, and said second perfluoroplastic is selected from the group consisting of PFA and FEP.

20. The method of claim 10 wherein said helical coil is formed from a metal.

21. The method of claim 10 wherein said helical coil is formed from a perfluoroplastic material.

22. The method of claim 21 wherein said perfluoroplastic material is a PTFE extrusion.

23. The method of claim 22 wherein said PTFE extrusion is sintered prior to being formed into said helical coil.

24. The method of claims 21-23 wherein said helical coil is thermally bonded to one of said tubes.

25. The method as claimed in claim 24 wherein said melt bondable adhesive is interposed between said outer tube and said helical coil, resulting in said helical coil being thermally bonded to said outer tube.
